(19) United States
(12) Patent Application Publication
(10) Pub. No.: US 2009/0087164 A1
(43) Pub. Date: Apr. 2, 2009

(54) Content Recording Medium, Content Recording Device and Content Playback Device

(76) Inventors: Masaki Chikahisa, Yokohama (JP); Hideki Sakao, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/175,741

(22) Filed: Jul. 18, 2008

(30) Foreign Application Priority Data
Sep. 28, 2007 (JP) 2007-253179

(51) Int. Cl. H04N 5/91

(52) U.S. Cl. 386/83

(57) ABSTRACT

In playing back a content in a content recording medium, when two types of contents of the identical program are recorded on a content recording medium with respect to the capabilities of the device attempting to play back the content, that is to say, content A allowing video to be played back but not audio, and content B allowing audio to be played back but not video, playback is not possible even if it would be possible to play back the content using video data in the content A and audio data in the content B. In the content recording device, when a content is recorded on a content recording medium, a re-encoding condition list is recorded on the content recording medium. Further, the content playback device allows for playback suitable for the capability of the content playback device by selecting separately playback data that are suitable for the capability of the playback device from the re-encoding condition list.

The present application is based on and claims priority of Japanese patent application No. 2007-253179 filed on Sep. 28, 2007, the entire contents of which are hereby incorporated by reference.

### BACKGROUND OF THE INVENTION

1. Field of the Invention

The present invention relates to a technique for providing a content among digital content recording/playback devices in a format adapted to each playback device.

2. Description of the Related Art

In multimedia data processing systems, data generated by multiplexing encoded video and audio data is entered, as typified by program streams or transport streams (hereinafter sometimes abbreviated to “TS”) standardized by the Moving Picture Experts Group (MPEG) of ISO/IEC.

For example, in the TS, a plurality of pieces of encoded video and audio data are packetized and multiplexed, which are identified by packet IDs assigned thereto, as described in “ATSC DIGITAL TELEVISION STANDARD Doc. A/53” and “ATSC DIGITAL TELEVISION STANDARD Doc. A/54”, and “Illustrated Latest MPEG Textbook (edited by Multi-media Communication Research Association under the supervision by Hiroshi Fujiwara)” and “Illustrated Practical MPEG Textbook (edited by Multi-media Communication Research Association under the supervision by Hiroshi Fujiwara)”.

Recently, large-capacity, portable storage media (hereinafter sometimes referred to as bridge media (registered trademark)) have become widespread. Some of these bridge media have a function of securing a copyright, and they are used for distribution of a digital content. For example, for an Information Versatile Disk for Removable usage (iVDR: removable hard disk), a Security Architecture For Intelligent Attachment device (SAFIA) is adopted as a content protection technique, and a content is recorded in a transport stream format.

These bridge media (registered trademark) can be recorded and played back by various content playback devices, such as a personal computer, a hard disk recorder, a digital video camera, a digital camera, an audio player, a car navigation system, a mobile phone or the like. However, some playback devices cannot play back a content due to such constraints as there is not sufficient processing performance to play back the content, the format of video/audio is not supported, the performance of an output device for the video/audio is insufficient.

For the above reason, when the content is played back by a playback device, a content recording device must convert the content into a format that can be played back by the playback device in advance.

Therefore, for example, in a recording medium, a content recording/playback system, a content playback device, a content recording device and a content re-encoding device, which are described in International Laid-Open Publication WO 2003/042915 (Patent Document 1), information required for the content playback device to play back the content has been recorded on the recording medium in advance, then, based on the information recorded on the recording medium, the content recording device performs processing, such as encoding, on the content, and records the content on the recording medium. The playback device can perform content playback by selecting a content suitable for the playback device based on the playback conditions recorded on the recording medium.

In order for the above prior art to play back a content in the bridge media (registered trademark), a capability table of the capabilities that can be played back by the device attempting to play back the content, or less, must be registered with the capability table of the playback device recorded on the capability management area in the bridge media (registered trademark).

When two types of capability tables are recorded on the bridge media (registered trademark) with respect to the capabilities of the device attempting to play back the content, that is to say, a capability table A allowing video to be played back but not audio, and a capability table B allowing audio to be played back but not video, playback is not possible even if it would be possible to play back the content using video data in the capability table A and audio data in the capability table B, requiring a new capability table of the playback apparatus to be added to the capability management area, and re-encoding processing to be performed again in the content recording device.

Further, in some devices for performing re-encoding processing, finer parameters cannot be set, therefore, a content having a capability lower than the capability described in the capability table of the playback device is sometimes generated and recorded. When another playback device having a lower playback capability is used to play back the bridge media (registered trademark), since the content has been recorded on the capability table as having a higher capability, the content is sometimes determined not to be played back regardless of the fact that the recorded content itself has been recorded with a capability allowing for playback.

### SUMMARY OF THE INVENTION

A removable content recording medium of the present invention, which has an area for storing a content, and is inserted into a playback device to play back the content recorded on the area, comprises an area for storing encoding information of the content, in addition to the area for storing the content.

Further, a content recording device of the present invention comprises means for reading a plurality of replayable conditions, which have been registered with the recording medium in advance, at the time of recording the content, means for setting the conditions for encoding the content based on the read plurality of conditions, and means for recording encoding information of the encoded content on the recording medium.

Moreover, a content playback device of the present invention comprises means for reading a plurality of pieces of content encoding information, which have been registered with the recording medium in advance, at the time of playing back the content, means for determining image data and voice data that can be played back by the playback device based on the read plurality of pieces of information, and means for extracting the determined data from the content.

According to the present invention, even if video data and audio data suitable for the capability of the playback device have been recorded on the content recording medium as intended for a different playback device, both data can be played back by the content playback device. For example, even when the content recording medium is inserted into a content playback device, which is used for the first time, if the video capability and audio capability of the playback device are satisfied, playback can be performed without re-encoding processing of the content, which has an effect of reducing re-encoding processing operations.

Furthermore, when a plurality of conditions for playing back video or a plurality of conditions for playing back audio are the same for playback devices, re-encoding data is shared to reduce the processing amount of re-encoding of the content, which has also an effect of reducing the overall volume of the content to be recorded on the content recording medium.

### BRIEF DESCRIPTION OF THE DRAWINGS

FIG. 1 is a diagram showing a content recording medium according to an embodiment of the present invention;

FIG. 2 is a diagram showing a content re-encoding device according to the embodiment of the present invention;

FIG. 3 is a diagram showing a content playback device according to the embodiment of the present invention;

FIG. 4 is a diagram showing an example of a playback device capability information table according to the embodiment of the present invention;

FIG. 5 is a diagram showing an example of a video parameter list according to the embodiment of the present invention; and

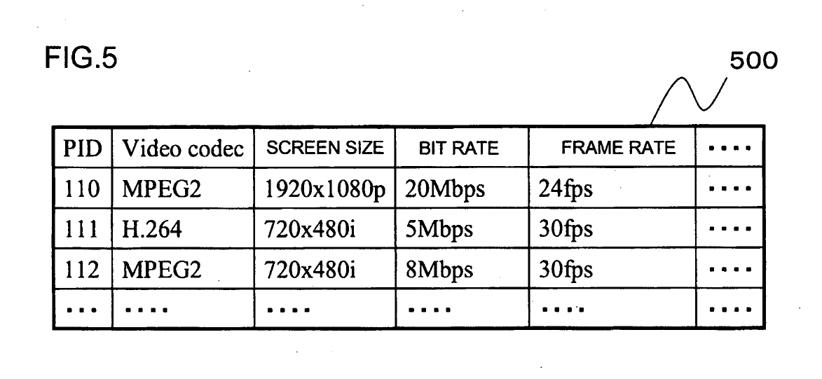

FIG. 6 is a diagram showing an example of an audio parameter list according to the embodiment of the present invention.

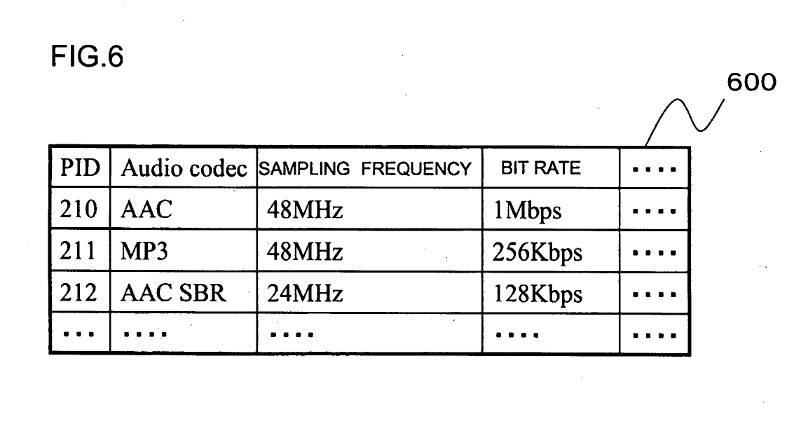

### DETAILED DESCRIPTION OF THE PREFERRED EMBODIMENTS

Hereinafter, an embodiment of the present invention will be described with referent to the drawings.

### [Embodiment 1]

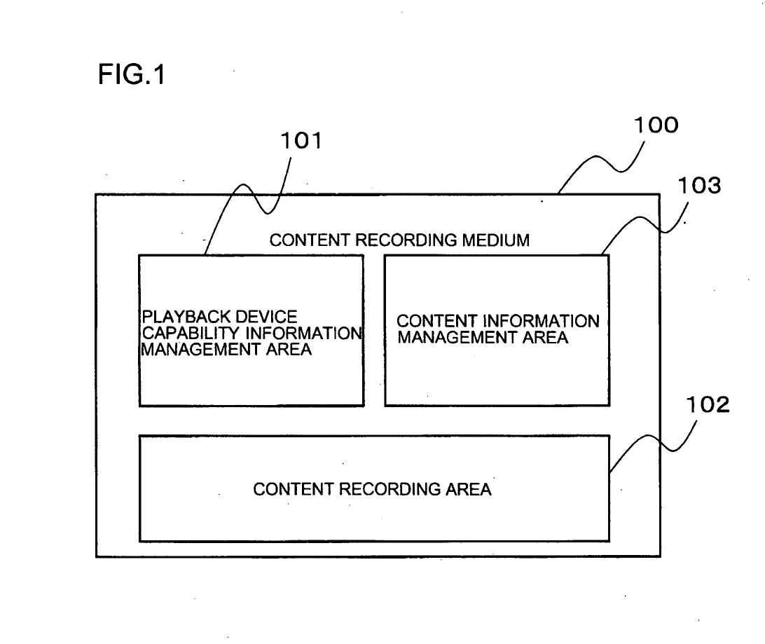

FIG. 1 shows a content recording medium 100 used in an embodiment 1. The content recording medium 100 has a playback device capability information management area 101 on which information of a content playback device capability table 400, which will be described later, is recorded, a content recording area 102 in which a content generated by a recording device is stored, and a content information management area 103 generated by the recording device.

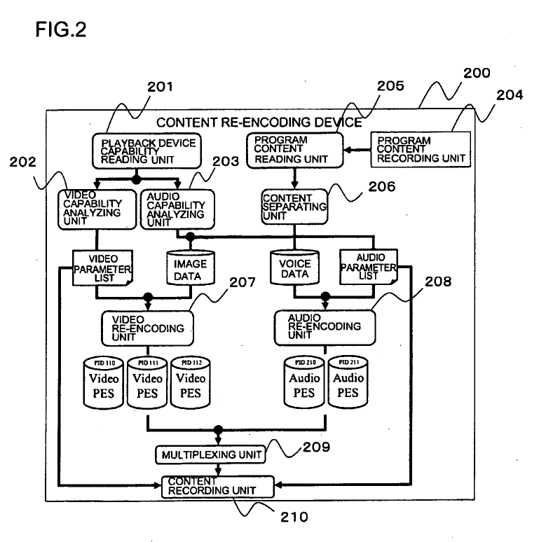

FIG. 2 shows a content re-encoding device 200 according to the present embodiment 1. The content re-encoding device 200 comprises a playback device capability table reading unit 201, a video capability analyzing unit 202, an audio capability analyzing unit 203, a program content recording unit 204, a program content reading unit 205, a content separating unit 206, a video re-encoding unit 207, an audio re-encoding unit 208, a multiplexing unit 209 and a content recording unit 210.

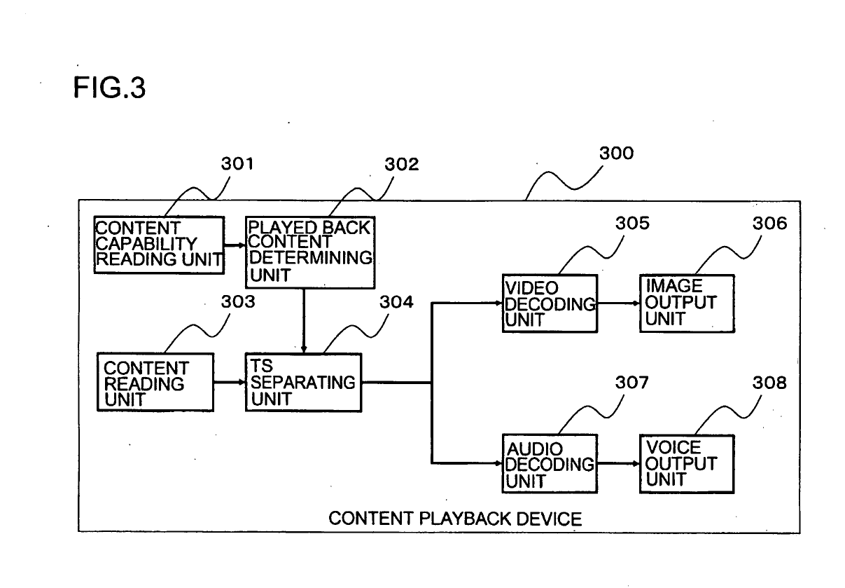

FIG. 3 shows a content playback device according to the present embodiment 1. The content playback device comprises a content capability reading unit 301, a played back content determining unit 302, a content reading unit 303, a TS separating unit 304, a video decoding unit 305, an image output unit 306, an audio decoding unit 307 and a voice output unit 308.

A method will be described in which a content is re-encoded by the content re-encoding device 200, the content is recorded on the content recording medium 100, and the content is played back by the content playback device 300.

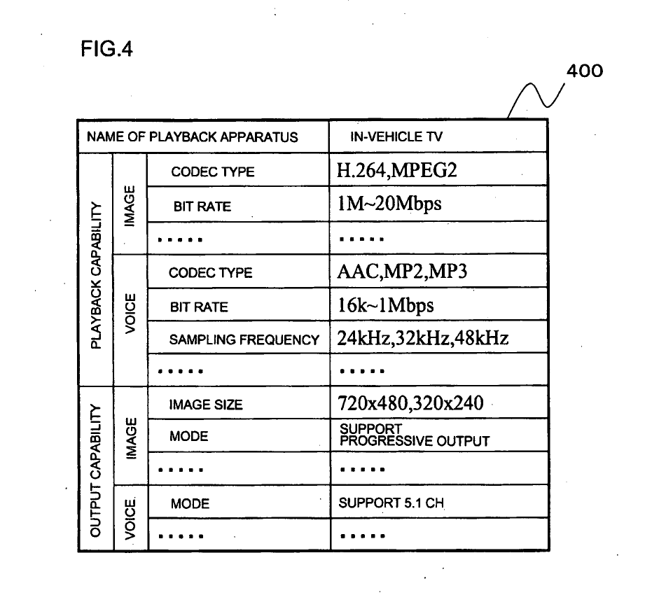

The content recording medium 100 is inserted into the content playback device 300, and the content playback device capability table 400, which includes video playback capability data of the video decoding processing unit, image output capability data of the video output unit, audio playback capability data of the audio decoding processing unit, and voice output capability data of the audio output unit in the content playback device, is recorded on the playback device capability information management area 101. FIG. 4 shows an example of the playback device capability information table 400. The playback device capability information management area 101 may be accessible to a user, in which case the user can edit the area.

Next, the content recording medium 100 is inserted into the content re-encoding device 200. The playback device capability information table reading unit 201 reads the content playback device capability table 400 recorded on the playback device capability information management area 101 in the content recording medium 100 according to directions from a user.

The video capability analyzing unit 202 extracts video playback capability data and image output capability data for each playback device from one or more content playback device capability tables 400 selected by the user, and generates a video parameter list 500 required for playback. At that time, if there are identical parameters, they are combined into one parameter. The generated video parameter list 500 includes parameters for re-encoding video data, and the IDs of packets (PID) required for Packetized Elementary Stream (PES) packet conversion.

The audio capability analyzing unit 203 extracts audio playback capability data and voice output capability data for each playback device from one or more content playback device capability tables 400 selected by the user, and generates an audio parameter list 600 required for playback. At that time, if there are identical parameters, they are combined into one parameter. The generated audio parameter list 600 includes parameters for re-encoding audio data, and PIDs required for PES packet conversion.

The program content reading unit 205 reads a program content specified by the user from the program content recording unit 204. At that time, the program content may be read from the content recording area 102 in the content recording medium 100, not from the recording unit in the content re-encoding device 200.

The content separating unit 206 separates the program content into image data and voice data. The video re-encoding unit 207 re-encodes the separated image data according to the video parameter list 500, and carries out PES packetization according to the PIDs in the video parameter list 500 to generate a plurality of re-encoded video PES packets.

The audio re-encoding unit 208 re-encodes the separated voice data according to the audio parameter list 600, and carries out PES packetization according to the PIDs in the audio parameter list 600 to generate a plurality of re-encoded audio PES packets.

Note that although when a content recorded on the program content recording unit 204 has already been encoded, the encoded content is separated into image data and voice data and expanded by the content separating unit 206, and re-encoded by the video re-encoding unit 207 and the audio re-encoding unit 208, when the content recorded on the program content recording unit 204 has not been encoded, modification may be made so that encoding is performed by the video re-encoding unit 207 and the audio re-encoding unit 208.

The multiplexing unit 209 multiplexes a plurality of pieces of video PES data and a plurality of pieces of audio PES data to generate one transport stream.

The content recording unit 210 records the transport stream on the content recording area 102 in the bridge media (registered trademark), and records the video parameter list 500 and the audio parameter list 600 on the content information management area 103.

Next, the content recording medium 100 is inserted into the content playback device 300. The content capability reading unit 301 reads the video parameter list 500 and the audio parameter list 600 of the content recorded on the content information management area 103 in the content recording medium 100.

The played back content determining unit 302 determines the PID of the decodable video PES packet in the video parameter list 500 based on the capability of the video decoding unit 305 and the image output unit 306 in the content playback device 300, and determines the PID of the decodable audio PES packet in the audio parameter list 600 based on the capability of the audio decoding unit 307 and the voice output unit 308.

The content reading unit 303 reads a content recorded on the content recording area 102 in the content recording medium 100.

The TS separating unit 304 uses the video PID and the audio PID determined by the played back content determining unit 302 to extract a video PES packet and an audio PES packet from the read transport stream.

The video decoding unit 305 decodes the video PES packet extracted by the TS separating unit 304, and the image output unit 306 outputs the video of the content.

The audio decoding unit 307 decodes the audio PES packet extracted by the TS separating unit 304, and the voice output unit 308 outputs the audio of the content.

As described above, in the embodiment 1, since whether or not decoding is possible is determined from the parameter lists used for re-encoding, playback of the content is possible if the video parameter list 500 and the audio parameter list 600 have been registered, which are also replayable in the content playback device 300 into which the content recording medium 100 is inserted for the first time.

Further, since identical re-encoding conditions are combined before re-encoding, the processing amount required for re-encoding can be reduced, and the overall volume of the content to be recorded on the content recording medium 100 can also be reduced.

What is claimed is:

1. A removable content recording medium, which has a content storage area for storing a content, and is inserted into a playback device to play back the content recorded on the content storage area, comprises a content information management area for storing a plurality of pieces of encoding information for encoding the content, in addition to the content storage area for storing the content.

2. The content recording medium according to claim 1, further comprising a playback device capability information management area for storing conditions allowing the playback device to play back the content.

3. The content recording medium according to claim 2, wherein the conditions allowing the playback device to play back the content comprise at least processing performance of a decoding processing unit, and performance of an output device.

4. The content recording medium according to any of claims 1 to 3, wherein the encoding information is re-encoding information for the encoded content.

5. The content recording medium according to any of claims 1 to 3, wherein the encoding information comprises at least information for associating a re-encoding parameter for video with a content, and information for associating a re-encoding parameter for audio with the content.

6. A content recording device for encoding and recording a content on a removable recording medium, comprising means for reading a plurality of replayable conditions, which have been registered with the recording medium in advance, at the time of recording the content, means for setting the conditions for encoding the content based on the read plurality of conditions, and means for recording encoding information of the encoded content on the recording medium.

7. A content recording device for re-encoding and recording a content on a removable recording medium, comprising means for reading a plurality of replayable conditions, which have been registered with the recording medium in advance, at the time of recording the content, means for setting the conditions for re-encoding the content based on the read plurality of conditions, and means for recording re-encoding information of the re-encoded content on the recording medium.

8. A content playback device for playing back a content from a removable recording medium, comprising means for reading a plurality of pieces of content encoding information, which have been registered with the recording medium in advance, at the time of playing back the content, means for determining image data and voice data that can be played back by the playback device based on the read plurality of pieces of information, and means for extracting the determined data from the content.

9. A content playback device for playing back a content from a removable recording medium, comprising means for reading a plurality of pieces of content re-encoding information, which have been registered with the recording medium in advance, at the time of playing back the content, means for determining image data and voice data that can be played back by the playback device based on the read plurality of pieces of information, and means for extracting the determined data from the content.
